(19) United States
(12) Patent Application Publication
(10) Pub. No.: US 2024/0004121 A1
(43) Pub. Date: Jan. 4, 2024

(54) Illumination-Based Privacy System

(71) Applicant: Apple Inc., Cupertino, CA (US)

(72) Inventors: David E Kingman, San Francisco, CA (US); Albert J Golko, Saratoga, CA (US); Peter F Masschelein, Campbell, CA (US)

(21) Appl. No.: 18/468,581

(22) Filed: Sep. 15, 2023

Related U.S. Application Data
(63) Continuation of application No. PCT/US2022/023137, filed on Apr. 1, 2022.
(60) Provisional application No. 63/172,015, filed on Apr. 7, 2021.

(51) Int. Cl. F21V 8/00

(52) U.S. Cl. CPC G02B 6/0041; G02B 6/0095; G02B 6/0076; G02B 6/0063; B60J 3/00

(57) ABSTRACT

A system may have windows. Each window may have light guide structures. The light guide structures may be formed between inner and outer glass layers. Light sources may emit light into the light guide structures. The light guide structures may include light guide core layers that guide light from the light sources across the window. Light-scattering structures may be provided to extract light from the light guide core layers. Some of the guided light may be extracted inwardly to serve as interior illumination for the system. Some of the guided light may be extracted outwardly. The outwardly extracted light visually obscures the interior region from the outside of the system, thereby providing system occupants with privacy.

This application is a continuation of international patent application No. PCT/US2022/023137, filed Apr. 1, 2022, which claims priority to U.S. provisional patent application No. 63/172,015, filed Apr. 7, 2021, which are hereby incorporated by reference herein in their entireties.

### FIELD

This relates generally to structures that pass light, and, more particularly, to windows.

### BACKGROUND

Windows are used in buildings and vehicles. Windows may be formed from glass or other transparent material.

### SUMMARY

A system such as a vehicle or building may have windows. Each window may have light guide structures. The light guide structures may be formed between inner and outer glass layers.

Light sources such as light sources based on light-emitting diodes and/or lasers may emit light into the light guide structures. The light guide structures may include light guide core layers that guide light from the light sources across the window.

Light-scattering structures may be provided in the windows to extract light from the light guide core layers. The light-scattering structures may include textured light guide layers and/or embedded light-scattering particles. The light-scattering structures may have a density that varies as a function of distance from the light sources to help create even light extraction.

Some of the guided light may be extracted inwardly to serve as interior illumination for the system. Some of the guided light may be extracted outwardly. The outwardly extracted light visually obscures the interior region from outside of the system, thereby providing system occupants with privacy.

Light-guide structures in a window may be formed from one light guide core layer, a pair of stacked light guide core layers, or three or more core layers. The light-scattering structures that extract the outwardly directed light from the light-guide structures may have areas with irregular patterns to help visually obscure the interior.

### BRIEF DESCRIPTION OF THE DRAWINGS

FIG. 1 is a diagram of an illustrative system with windows in accordance with an embodiment.

FIG. 2 is a cross-sectional side view of an illustrative system with a window in accordance with an embodiment.

FIG. 3 is a cross-sectional side view of an illustrative window with illumination in accordance with an embodiment.

FIG. 4 is a cross-sectional side view of an illustrative window illumination system based on a light guide layer with light-scattering structures in accordance with an embodiment.

FIG. 5 is a cross-sectional side view of an illustrative window illumination system based on first and second stacked light guide core layers with light-scattering structures in accordance with an embodiment.

FIG. 6 is a cross-sectional side view of an illustrative window illumination system with three light guide core layers in accordance with an embodiment.

FIG. 7 is a diagram of an illustrative light guide having irregularly shaped light-scattering regions in accordance with an embodiment.

### DETAILED DESCRIPTION

A system may have one or more windows or other transparent structures. Light guides may be embedded in the windows. Light may be emitted into the light guides and may be guided within the light guides in accordance with the principal of total internal reflection. To provide internal and external illumination for the system, light-scattering structures may be provided that scatter light out of the light guides. Light that is scattered towards an interior region within the system may be used to illuminate objects in the interior region. Light that is scattered outwardly towards the external region surrounding the system helps to visually obscure internal objects. In this way, the light-scattering structures enhance privacy for occupants of the system located in the interior region.

The system in which the windows are used may be a building, a vehicle, or other suitable system. Illustrative configurations in which the system is a vehicle may sometimes be described herein as an example. This is merely illustrative. Window structures may be formed in any suitable systems.

A light guide for a window may be formed from a core sandwiched between claddings. The claddings, which may have lower refractive index values than the core to promote total internal reflection, may be formed from structural window layers and/or separate cladding layers. When light guide structures are provided in a vehicle window, the light guide structures may be used to distribute light laterally across the window. Light-scattering structures may be embedded in the core or portions of the cladding layers, may be formed from optical films placed adjacent to the core, and/or may otherwise be incorporated into each light guide to help extract light from the light guide.

A light source such as an array of light-emitting diodes, an array of lasers, and/or other light-emitting devices may be used to emit light into each light guide. For example, a light guide may be provided with illumination by coupling an array of visible light-emitting devices to one or more edges of a light guide layer. Light from the light source may propagate laterally across a window within a light guide in accordance with the principal of total internal reflection. When the guided light encounters light-scattering structures, light that is being guided within the light guide is extracted by the light-scattering structures.

The light extracted from the light guide in each window may include light that is directed into an interior region within the vehicle or other system. This internally directed light may serve as interior illumination for the vehicle or other system. The extracted light may also include light that is directed outwardly towards the exterior region surrounding the vehicle or other system. Outwardly directed light may obscure internally objects from view. For example, the light that is emitted from the light guide in the outward direction may partly or completely overwhelm the light that is illuminating the interior region (e.g., the outwardly extracted light may be as bright as or brighter than light from objects inside the system). This may make it difficult or impossible for an external viewer to view objects in the interior of the vehicle or other system. By providing most or all of the windows in the system with light guides that emit light towards the exterior region, occupants of the vehicle or other system may therefore be provided with privacy.

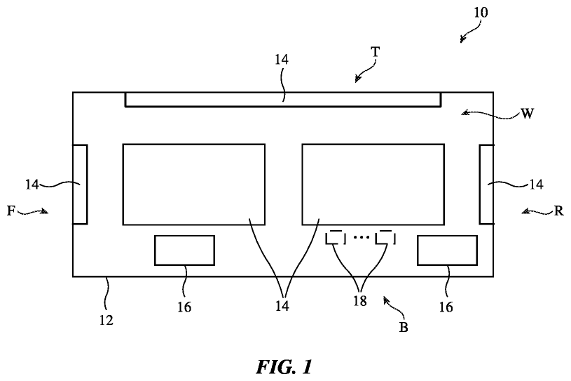

An illustrative system of the type that may include windows is shown in FIG. 1. System 10 may be a vehicle, building, or other type of system. In an illustrative configuration, system 10 is a vehicle. As shown in the illustrative side view of system 10 in FIG. 1, system 10 may have support structures such as body 12. Body 12 may be a vehicle body that includes doors, trunk structures, a hood, side body panels, a roof, and/or other body structures. Body 12 may be configured to surround and enclose an interior region.

One or more windows such as windows 14 may be mounted within openings in body 12. Windows 14 may, for example, be mounted on front F of body 12 (e.g., to form a front window on the front of a vehicle), rear R of body 12 (e.g., to form a rear window at the rear of a vehicle), top T of body 12 (e.g., to form a sun roof), and/or on sides W of body 12 (e.g., to form side windows). The area of each window 14 may be at least 0.1 m², at least 0.5 m², at least 1 m², at least 5 m², at least 10 m², less than 20 m², less than 10 m², less than 5 m², or less than 1.5 m² (as examples). Windows 14 and portions of body 12 may be used to separate the interior region within system 10 from the exterior environment that is surrounding system 10.

System 10 may include a chassis to which wheels are mounted (e.g., wheels 16), may include propulsion and steering systems, may include a vehicle automation system configured to support autonomous driving (e.g., a vehicle automation system with sensors and control circuitry configured to operate the propulsion and steering systems based on sensor data). This allows system 10 to be driven semi-autonomously and/or allows system 10 to be driven autonomously without a human operator.

Illustrative components 18 for system 10 are shown in FIG. 1. Components 18 may include seats in the interior of body 12, sensors, control circuitry, input-output devices, and/or other vehicle components. Control circuitry in system 10 may include one or more processors (e.g., microprocessors, microcontrollers, application-specific integrated circuits, etc.) and storage (e.g., volatile and/or non-volatile memory). Input-output devices in system 10 may include displays, sensors, buttons, light-emitting diodes and other light-emitting devices, haptic devices, speakers, and/or other devices for providing output and/or for gathering environmental measurements and/or user input. The sensors may include ambient light sensors, touch sensors, force sensors, proximity sensors, optical sensors, capacitive sensors, resistive sensors, ultrasonic sensors, microphones, three-dimensional and/or two-dimensional images sensors, radio-frequency sensors, and/or other sensors. Output devices may be used to provide a user with haptic output, audio output, visual output (e.g., displayed content, light, etc.), and/or other suitable output.

During operation, control circuitry in system 10 may gather information from sensors and/or other input-output devices, user input such as voice commands provided to a microphone, a touch command supplied to a touch sensor, button input supplied to one or more buttons, etc. Control circuitry in system 10 may use this input in autonomously driving system 10 and in controlling components in system 10. For example, the control circuitry can adjust one or more adjustable components in each window 14. These components may include, for example, an adjustable illumination system.

Windows 14 may also include adjustable components such as layers that provide adjustable amounts of light transmission, haze, reflectivity, and/or other adjustable optical characteristics. As an example, windows 14 may include adjustable guest-host light modulator layers that can be used to control light transmission, may include polymer dispersed liquid crystal layers or other privacy films that may be adjusted to provide desired amounts of haze to enhance occupant privacy, may be provided with layers that exhibit a controlled amount of light reflection (e.g., cholesteric liquid crystal layers), and/or other adjustable optical films. Fixed films such as fixed polarizers, fixed partially reflective layers, fixed light absorption layers that absorb some of the light passing through windows 14, and/or other fixed optical films may also be included in windows 14.

One or more windows 14 in system 10 may be provided with the ability to partly or completely prevent external viewers from viewing objects in the interior of system 10. Illustrative configurations in which all windows 14 (including the front window on front F of system 10) may simultaneously be adjusted to emit outwardly extracted light to prevent viewing of the interior (which may therefore provide complete privacy from exterior viewers) may sometimes be described herein as an example.

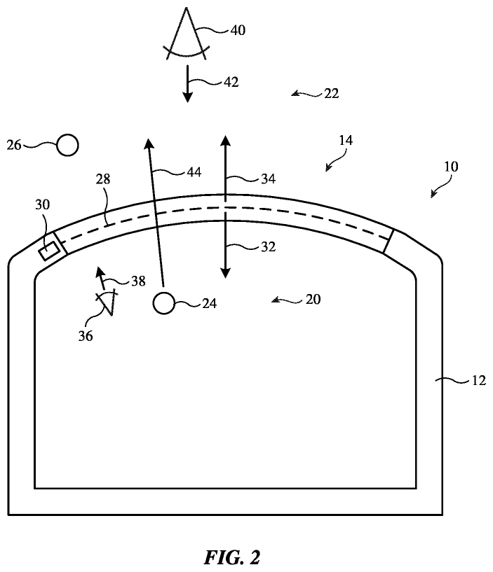

FIG. 2 is a cross-sectional view of an illustrative system. As shown in FIG. 2, body 12 and windows such as window 14 may separate interior region 20 and vehicle occupants and other objects 24 in interior region 20 from exterior region 22 and external objects 26 in exterior region 22. Window 14 may contain an embedded illumination system such as illumination system 28. System 28 may, as an example, include light guide structures forming a light guide that receives illumination from light source 30. The light guide may have a layer of polymer or glass that serves as a light guide core surrounded by cladding material formed from glass or polymer with a lower refractive index to promote total internal reflection. The light guide may be planar and/or may have a curved cross-sectional profile. For example, side windows in a vehicle may be planar or slightly curved, whereas front and rear windows may have more significant curvature and/or may exhibit compound curvature. In an illustrative configuration, some or all of the surface area of each window 14 is overlapped by a light guide forming a respective illumination system 28.

Light-scattering structures may be provided in each illumination system to extract guided light in both the inward and outward directions. Inwardly extracted light such as light 32 may serve to illuminate internal region 20 (see, e.g., internal objects such as internal object 24 which may include one or more vehicle occupants). Outwardly extracted light such as light 34 may be used to help visually obscure interior region 20 when system 10 is viewed from exterior region 22 by people in exterior region 22 (see, e.g., external viewer 40 who is viewing system 10 in direction 42).

Because window 14 is transparent, occupants of system 10 can view objects in exterior region 22. For example, a viewer in interior region 20 such as viewer 36 who is viewing objects such as object 26 in exterior region 22 may view these objects through window 14. External viewers such as viewer 40 in exterior region 22 who are viewing system 10 in direction 42 have an opportunity to view system occupants and other objects in interior region 20 such as object 24 through window 14. When sufficient outwardly extracted light is being provided by illumination system 28, however, the outwardly extracted light will overwhelm any light from interior objects and the will therefore visually obscure the interior objects.

Consider, as an example, a scenario in which system occupants and other objects in interior region 20 such as object 24 are being illuminated. Light 32 from illumination system 28 may illuminate object 24 and object 24 may be illuminated by ambient light from light sources outside of system 10 that is passing through window 14 from exterior region 22 to interior region 20. As a result of being illuminated, object light 44 from object 24 may pass through window 14 from interior region 20 to exterior region 22. At the same time, light 34 from illumination system 28 may be emitted outwardly by system 28. So long as the magnitude of light 34 is comparable to or greater than the magnitude of light 44 (e.g., so long as the intensity of light 34 is greater than or is at least that of the intensity of light 44 and/or is greater than or at least that of the intensity of light 32), it will be difficult or impossible for exterior viewer 40 to view object 24 satisfactorily through window 14. Privacy for occupants of system 10 may therefore be provided by adjusting system 28 to produce sufficient amounts of light 34 to prevent external viewer 40 from viewing objects 24 in interior region 20. As an example, occupants of system 10 may be provided with privacy at night, when exterior region 22 is dark.

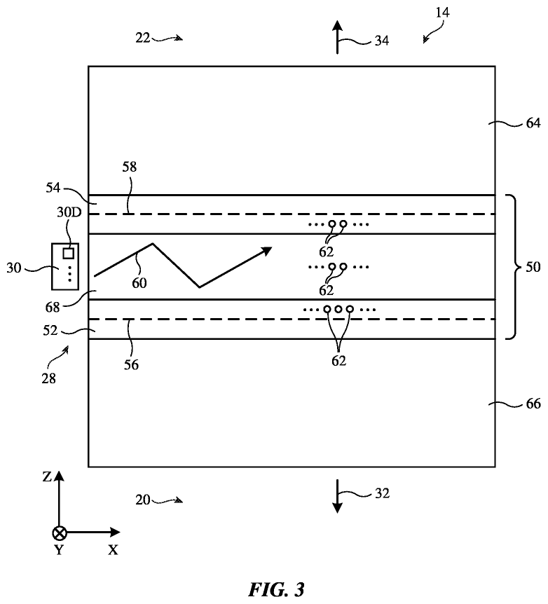

A cross-sectional side view of an illustrative window of the type that may be used in system 10 is shown in FIG. 3. Window 14 may be formed from one or more layers of transparent glass, clear polymer (e.g., polycarbonate, acrylic, etc.), polymer adhesive, and/or other layers. As shown in FIG. 3, a light guide (optical waveguide) such as light guide layer 50 may be sandwiched between outer window layer 64 and inner window layer 66. Outer window layer 64 may include multiple sublayers such as one or more layers of glass, optically clear adhesive, and/or polymer films. Inner window layer 66 may similarly include multiple sublayers such as one or more layers of glass, optically clear adhesive, and/or polymer films. The outer and inner window layers may, as an example, include, respectively, an outer structural window layer such as a structural glass layer that is attached to an outer surface of light guide layer 50 and an inner structural window layer such as a structural glass layer that is attached to an opposing inner surface of light guide layer 50. In some configurations, optical component layers such as optical modulator layers and/or other optical layers may be incorporated into window 14. If desired, windows such as window 14 may also be provided with three or more glass layers or other structural layers or may only include a single structural glass layer.

Light guide layer 50 may be used to form an illumination system for window 14 (e.g., illumination system 28 of FIG. 2). During operation, light source 30 may emit light 60 into light guide layer 50. Light 60 may be guided across window 14 within layer 50 (e.g., in the X direction of FIG. 1) in accordance with the principal of total internal reflection. In some configurations, light 60 may spread in the Y dimension while traveling across the window in the X dimension.

Source 30 may include light-emitting devices 30D such as one or more light-emitting diodes and/or lasers. Devices 30D may emit visible light of one or more colors (e.g., white light of one or more color temperature such as cool white light and/or warm white light, light of other colors such as red light, blue light, green light, etc.). The color of emitted light 60 may be dynamically adjusted by the control circuitry of system 10 by adjusting source 30 to control the relative intensity of the light emitted by each of devices 30D. The light-emitting devices of light source 30 may be distributed along the edge of light guide layer 50 (e.g., along the Y dimension in the example of FIG. 3). If desired, sources such as source 30 may be placed along multiple edges of light guide layer 50 (e.g., along both the right and left edges of layer 50 in FIG. 3, along all four edges of a light guide layer that has a rectangular footprint, etc.). The configuration of FIG. 3 in which layer 50 is provided with light 60 from light source 30 along the left-hand edge of layer 50 is illustrative.

Layers of adhesive (e.g., optically clear adhesive) may be used to attach light guide layer 50 to adjacent layers such as layer 64 and layer 66 and may be used to attach sublayers within layer 50 to each other. Such adhesive layers may have thicknesses of less than 1 mm, less than 0.8 mm, less than 0.5 mm, less than 0.2 mm, less than 0.1 mm, less than 0.05 mm, less than 0.025 mm, at least 0.05 mm, at least 0.2 mm, or at least 0.4 mm (as examples).

One or more regions of light guide layer 50 in window 14 may be provided with light-scattering structures 62. As an example, most or all of window 14 may be covered with light-scattering structures 62. When light 60 that is being guided in light guide layer 50 reaches light-scattering structures 62, this guided light can be scattered out of light-guide layer 50 to form outwardly extracted (scattered) light 34 and inwardly extracted (scattered) light 32. Light 32 may serve as interior illumination for system 10 and may illuminate objects in interior region 20. For example, in a vehicle window, light 32 may serve as interior vehicle illumination. Light 34 may be directed towards external viewers such as viewer 40 of FIG. 2 and may visually obscure objects in interior 20, thereby providing vehicle occupants with privacy.

Structures 62 may be formed in light guide layer 50 and/or an adjacent layer (e.g., an adjacent layer of polymer or glass). As an example, light guide layer 50 may have a transparent core such as core layer 68 surrounded by cladding layers 52 and 54 and structures 62 may include light-scattering particles or other structures that are embedded within core 68 and/or within cladding layers 54 and 52. Light-scattering structures 62 may also include recesses and/or protrusions on one or more surfaces of core layer 68 and/or layers 52 and/or 54. If desired, light-scattering structures 62 may be formed from polymer films (see, e.g., films 58 and 56, which may form part of cladding layers 54 and 52 or which may be separate polymer layers). The distribution of light-scattering structures 62 within window 14 (e.g., within light guide layer 50) may be configured to provide satisfactory inward light scattering and satisfactory outward light scattering. When sufficient inward light scattering is provided, inwardly extracted light may be used to illuminate objects in the interior of system 10. When sufficient outward light scattering is provided, outwardly extracted light may be used to obscure the visibility of interior objects and thereby provide desired privacy.

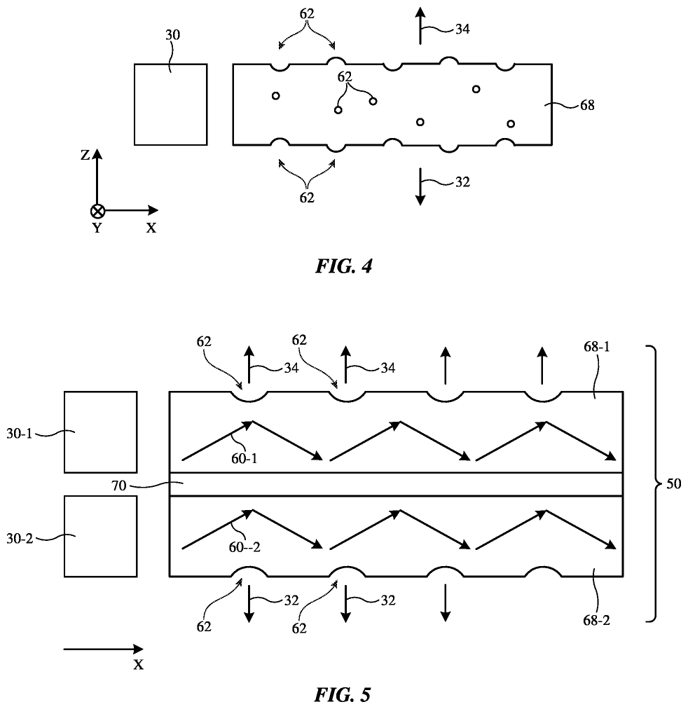

FIG. 4 is a cross-sectional side view of an illustrative light guide layer having a core layer with light-scattering structures 62 (as an example). Light-scattering structures 62 may be formed from inorganic particles (e.g., metal oxide particles or other inorganic dielectric particles having a refractive index that differs from the refractive index of surrounding polymer material in which the particles are embedded) and/or may be formed from protrusions and/or recesses (e.g., surface texture) associated with light guide layer 50 or an adjacent layer. As shown in the example of FIG. 4, light-scattering structures 62 may include light-scattering particles embedded within core layer 68, protrusions (e.g., bumps and/or ridges) on one or both surfaces of layer 68, and/or recesses (e.g., pits and/or grooves) on one or both surfaces of layer 68.

Light-scattering particles for forming light-scattering structures 62 may be formed from glass beads, particles of metal oxide such as titanium oxide particles or zirconium oxide particles, particles of silicon oxide, or other inorganic dielectric particles (e.g., particles that have refractive index values that differ from the transparent polymer, glass, or other material used in forming core layer 68). If desired, gas bubbles or other voids may be used to create light-scattering structures in core 68. If desired, light-scattering particles or other light-scattering structures may also be formed in cladding layers or other layers adjacent to light guide 50.

The shape, size, and distribution of light-scattering structures 62 may be selected to produce desired amounts of inwardly extracted light 32 and outwardly extracted light 34. For a given amount of light emitted into core layer 68 from light source 30, the magnitude of light 32 may be greater than the magnitude of light 34, may be equal in magnitude to light 34, or may be less in magnitude than light 34. To ensure even illumination extraction across the X and Y dimensions, it may be desirable to vary the density of light-scattering structures 62 across window 14. For example, the density of structures 62 may be increased as a function of increasing distance from light source 30 (e.g., as a function of increasing distance in the X direction in the example of FIG. 4). This increase in light-scatting structure density may help compensate for the decrease in propagating light intensity for light 60 in core 68 as a function of increasing distance from light source 30 due to light extraction by structures 62. As a result of the increasing density of structures 62, the intensity of light emitted inwardly and outwardly from window 14 may remain relatively constant across the surfaces of window 14.

If desired, light guide layer 50 may be provided with multiple parallel light guide layers. For example, two light guide core layers 68-1 and 68-2 may be stacked adjacent to each other as shown in FIG. 5 (e.g., with an intervening cladding layer such as layer 70). Light-scattering structures 62 may be formed in layers 68-1 and 68-2. For example, layer 68-1 may face outwardly and may have light-scattering structures 62 that predominantly help scatter light 60-1 in layer 68-1 outwardly to form light 34, whereas layer 68-2 may lie on the inwardly facing side of layer 50 and may have light-scattering structures 62 that predominantly help scatter light 60-2 inwardly to form light 32. Light-emitting devices in independently adjusted light sources 30-1 and 30-2 may emit light 60-1 and 60-2 into layers 68-1 and 68-2, respectively. By adjusting the relative strength of sources 30-1 and 30-2, the relative intensity of light 34 and light 32 may be controlled. This allows interior illumination (associated with the magnitude of light 32) and privacy (associated with the magnitude of light 34) to be controlled independently.

Control circuitry in system 10 may adjust the interior illumination and privacy settings of system 30 based on user input, sensor readings (e.g., ambient light readings, sensor readings detecting people in the exterior region surrounding system 10, etc.), time of day, system status information such as information on whether system 10 is being driven (e.g., whether system 10 is in motion and/or whether an autonomous driving system has been activated), whether occupants are in interior region 20, whether system 10 is being driven autonomously (in which case the illumination system in each window including the front window at front F may be illuminated to provide interior illumination and privacy), and/or other conditions.

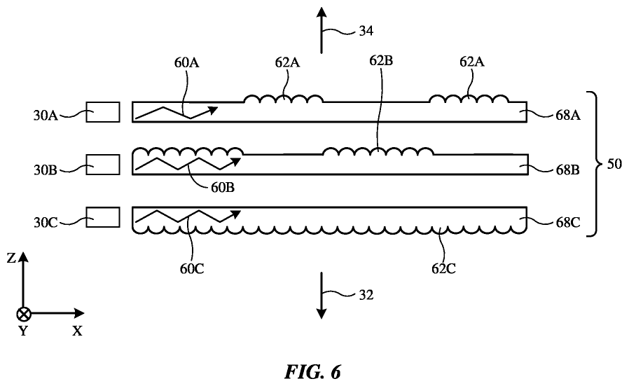

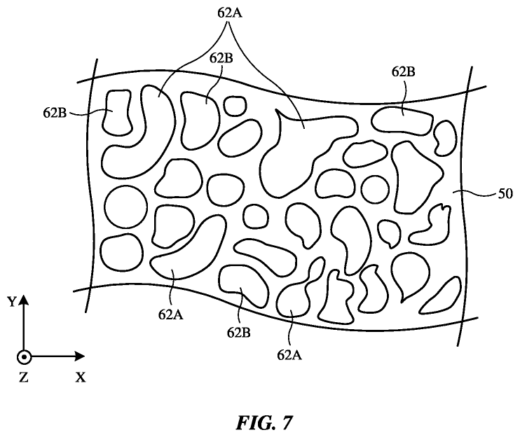

It may be desirable to create fixed and/or adjustable patterns in outwardly extracted light 34. An illustrative configuration for light guide layer 50 in which multiple core layers are used to provide adjustable amounts of interior and exterior light is shown in FIG. 6. As shown in FIG. 6, light guide layer 50 may contain three core layers 68A, 68B, and 68C, which are provided with light 60A, 60B, and 60C by respective independently adjustable light sources 30A, 30B, and 30C. The core layers of light guide layer 50 of FIG. 6 may be separated from each other by intervening cladding layers.

Light-scattering structures 62C may be formed on the inner surface of layer 68C and may be used so that light 60C is predominantly scattered inwardly to form light 32. Light scattering structures 62A and 62B may be patterned in overlapping and/or non-overlapping areas of the outwardly facing surfaces of layers 68A and 68B, respectively. In the example of FIG. 6, light-scattering structures 62A and 62B are formed in non-overlapping areas of layers 68A and 68B, respectively. Structures 62A and 62B may have regular shapes (e.g., shapes that form rectangular strips across the surfaces of layer 68A and 68B, respectively, shapes that form symbols or letters, etc.), and/or may be patterned in other regular or irregular shapes. FIG. 7 an exterior view of layer 50 showing how structures 62A and 62B may be formed in interspersed non-overlapping irregular (e.g., random) areas to form respective irregular light-emitting patterns. During operation, the intensity of light 30A and 30B may be varied in color and/or intensity to help create time-varying patterns and intensities of emitted light 32 associated, respectively, with structures 62A and 62B. The spatial variations (irregular areas of light-scattering structures 62), spectral variations (changes in color of the emitted light), and/or intensity variations produced by light guide layer 50 in this type of arrangement may help make it difficult or impossible for an external viewer to view objects in interior 20, thereby enhancing privacy. The color and intensity of light 32 emitted inwardly by light guide 50 may be used to independently adjust the internal illumination of system 10.

In accordance with an embodiment, a system is provided that includes a body; and a window in the body that separates an exterior region surrounding the body from an interior region within the body, the window includes first and second window layers; a light source configured to emit light; and a light guide layer between the first and second window layers, the light guide layer guides the light from the light source and the light guide layer has light-scattering structures configured to scatter the guided light outwardly to create outwardly scattered light that visually obscures the interior region from the exterior region.

In accordance with another embodiment, the light-scattering structures are configured to scatter some of the guided light inwardly to create inwardly scattered light having an inwardly scattered light intensity and the outwardly scattered light has an outwardly scattered light intensity that is greater than the inwardly scattered light intensity.

In accordance with another embodiment, the light-scattering structures are further configured to scatter the guided light inwardly to create inwardly scattered light that serves as illumination for the interior region.

In accordance with another embodiment, the body includes a vehicle body and the window includes a vehicle window.

In accordance with another embodiment, the light guide layer includes first and second stacked light guide cores.

In accordance with another embodiment, the light-scattering structures include first light-scattering structures on an outwardly facing surface of the first light guide core and second light-scattering structures on an inwardly facing surface of the second light guide core.

In accordance with another embodiment, the light source includes a first light-emitting device configured to emit light into the first light guide core and includes a second light-emitting device configured to emit light into the second light guide core.

In accordance with another embodiment, the system includes control circuitry configured to control the first light-emitting device to adjust the outwardly scattered light and configured to control the second light-emitting device to adjust the inwardly scattered light.

In accordance with another embodiment, the light-scattering structures include first light-scattering structures in the first light guide core that produce a first portion of the outwardly scattered light and second light-scattering structures in the second light guide core that produce a second portion of the outwardly scattered light.

In accordance with another embodiment, the first and second light-scattering structures are formed in first and second non-overlapping areas of the window.

In accordance with an embodiment, a vehicle window configured to separate an interior region in a vehicle from an exterior region surrounding the vehicle, the vehicle window is provided that includes a first glass layer; a second glass layer; a light source configured to provide light; light guide structures between the first and second glass layers, the light guide structures are configured to guide the light; and light-scattering structures configured to scatter some of the light inwardly to illuminate the interior region while scattering some of the light outwardly to visually obscure the interior region from the exterior region.

In accordance with another embodiment, the light guide structures include a light guide core layer that guides the light.

In accordance with another embodiment, the light guide structures include three stacked light guide core layers.

In accordance with another embodiment, the light guide structures include first light scattering structures on a first of the three stacked light guide core layers; second light scattering structures on a second of the three stacked light guide core layers; and third light scattering structures on a third of the three stacked light guide core layers.

In accordance with another embodiment, the light guide structures include first and second light guide core layers between the first and second glass layers and the light source include a first light-emitting device at an edge of the first light guide core layer and a second light-emitting device at an edge of the second light guide core layer.

In accordance with another embodiment, the light-scattering structures include first light scattering structures configured to scatter light from the first light guide core layer outwardly and second light scattering structures configured to scatter light from the second light guide core inwardly.

In accordance with another embodiment, the light-scattering structures are patterned to form irregular areas of outwardly scattered light visible through the first glass layer.

In accordance with an embodiment, a vehicle is provided that includes a vehicle body surrounding an interior region; and windows in the body that each have a light guide layer configured to emit light inwardly towards the interior region to serve as interior illumination and outwardly to serve as outward illumination that visually obscures the interior region.

In accordance with another embodiment, the windows include a front window that emits at least some of the interior illumination and that emits at least some of the outward illumination.

In accordance with another embodiment, the vehicle includes an autonomous driving system that is operated while the front window emits the inward illumination and the outward illumination.

In accordance with another embodiment, each window has a light source configured to emit light into the light guide layer and each window has light-scattering structures configured to scatter guided light from the light guide layer outwardly and inwardly.

The foregoing is merely illustrative and various modifications can be made to the described embodiments. The foregoing embodiments may be implemented individually or in any combination.

What is claimed is:

1. A system, comprising:
a body; and
a window in the body that separates an exterior region surrounding the body from an interior region within the body, wherein the window comprises:
first and second window layers;
a light source configured to emit light; and
a light guide layer between the first and second window layers, wherein the light guide layer guides the light from the light source and wherein the light guide layer has light-scattering structures configured to scatter the guided light outwardly to create outwardly scattered light that visually obscures the interior region from the exterior region.

2. The system defined in claim 1 wherein the light-scattering structures are configured to scatter some of the guided light inwardly to create inwardly scattered light having an inwardly scattered light intensity and wherein the outwardly scattered light has an outwardly scattered light intensity that is greater than the inwardly scattered light intensity.

3. The system defined in claim 1 wherein the light-scattering structures are further configured to scatter the guided light inwardly to create inwardly scattered light that serves as illumination for the interior region.

4. The system defined in claim 3 wherein the body comprises a vehicle body and wherein the window comprises a vehicle window.

5. The system defined in claim 4 wherein the light guide layer comprises first and second stacked light guide cores.

6. The system defined in claim 5 wherein the light-scattering structures include first light-scattering structures on an outwardly facing surface of the first light guide core and second light-scattering structures on an inwardly facing surface of the second light guide core.

7. The system defined in claim 6 wherein the light source comprises a first light-emitting device configured to emit light into the first light guide core and comprises a second light-emitting device configured to emit light into the second light guide core.

8. The system defined in claim 7 further comprising control circuitry configured to control the first light-emitting device to adjust the outwardly scattered light and configured to control the second light-emitting device to adjust the inwardly scattered light.

9. The system defined in claim 5 wherein the light-scattering structures include first light-scattering structures in the first light guide core that produce a first portion of the outwardly scattered light and second light-scattering structures in the second light guide core that produce a second portion of the outwardly scattered light.

10. The system defined in claim 9 wherein the first and second light-scattering structures are formed in first and second non-overlapping areas of the window.

11. A vehicle window configured to separate an interior region in a vehicle from an exterior region surrounding the vehicle, the vehicle window comprising:
a first glass layer;
a second glass layer;
a light source configured to provide light;
light guide structures between the first and second glass layers, wherein the light guide structures are configured to guide the light; and
light-scattering structures configured to scatter some of the light inwardly to illuminate the interior region while scattering some of the light outwardly to visually obscure the interior region from the exterior region.

12. The vehicle window defined in claim 11 wherein the light guide structures comprise a light guide core layer that guides the light.

13. The vehicle defined in claim 11 wherein the light guide structures comprise three stacked light guide core layers.

14. The vehicle defined in claim 13 wherein the light guide structures comprise:
first light scattering structures on a first of the three stacked light guide core layers;
second light scattering structures on a second of the three stacked light guide core layers; and
third light scattering structures on a third of the three stacked light guide core layers.

15. The vehicle window defined in claim 11 wherein the light guide structures comprise first and second light guide core layers between the first and second glass layers and wherein the light source comprises a first light-emitting device at an edge of the first light guide core layer and a second light-emitting device at an edge of the second light guide core layer.

16. The vehicle defined in claim 15 wherein the light-scattering structures comprise first light scattering structures configured to scatter light from the first light guide core layer outwardly and second light scattering structures configured to scatter light from the second light guide core inwardly.

17. The vehicle defined in claim 11 wherein the light-scattering structures are patterned to form irregular areas of outwardly scattered light visible through the first glass layer.

18. A vehicle, comprising:
a vehicle body surrounding an interior region; and
windows in the body that each have a light guide layer configured to emit light inwardly towards the interior region to serve as interior illumination and outwardly to serve as outward illumination that visually obscures the interior region.

19. The vehicle defined in claim 18 wherein the windows include a front window that emits at least some of the interior illumination and that emits at least some of the outward illumination.

20. The vehicle defined in claim 19 further comprising an autonomous driving system that is operated while the front window emits the inward illumination and the outward illumination.

21. The vehicle defined in claim 19 wherein each window has a light source configured to emit light into the light guide layer and wherein each window has light-scattering structures configured to scatter guided light from the light guide layer outwardly and inwardly.
